(19) United States
(12) Patent Application Publication
(10) Pub. No.: US 2016/0333215 A1
(43) Pub. Date: Nov. 17, 2016

(54) ACTIVATING ENERGY BEAM-CURABLE COMPOSITION FOR FLOORING MATERIAL

(71) Applicant: DIC CORPORATION, Tokyo (JP)

(72) Inventors: Kazunari KAWAI, Tokyo (JP); Shingo KUSANO, Tokyo (JP)

(73) Assignee: DIC CORPORATION, Tokyo (JP)

(21) Appl. No.: 15/108,669

(22) PCT Filed: Dec. 18, 2014
(86) PCT No.: PCT/JP2014/083583

§ 371 Date: Jun. 28, 2016

(30) Foreign Application Priority Data
Jan. 8, 2014 (JP) 2014-001599

(51) Int. Cl. C09D 139/04; E04F 15/10; C09D 4/00

(52) U.S. Cl. CPC C09D 139/04; C09D 4/00; E04F 15/10

(57) ABSTRACT

Provided is an active energy ray-curable composition for flooring materials, which more strongly adheres to flooring materials that contain vinyl chloride while maintaining conventional physical performance. Specifically provided is an active energy ray-curable composition for flooring materials, which contains an active energy ray-polymerizable compound and a photopolymerization initiator, wherein the active energy ray-polymerizable compound includes a polyvinyl chloride-insoluble compound (A) which does not dissolve or does not substantially dissolve in polyvinyl chloride and a polyvinyl chloride-soluble compound (B) which dissolves in polyvinyl chloride, and the content of the compound (B) is in a range of 3% to 40% by weight with respect to the content of the compound (A).

### TECHNICAL FIELD

The present invention relates to an active energy ray-curable composition to be applied to the surface of flooring materials.

### BACKGROUND ART

Hitherto, flooring materials made of synthetic resins such as polyvinyl chloride have been widely used as floor finishing materials for buildings and vehicles. Flooring materials made of synthetic resins are likely to be attached to dirt (heel mark) due to friction between the materials and shoe soles at the time when a person is wearing shoes and walking, and thus, the flooring materials generally are poor in contamination resistance. Therefore, an antifouling treatment such as a waxing treatment is usually carried out after construction of the flooring materials. However, in order to maintain antifouling properties, it is necessary to perform maintenance of periodically removing old wax and carrying out a waxing treatment again. This maintenance work is high in cost and time-consuming, and further has many disadvantages in terms of environment, for example, the work causes a large amount of liquid waste.

As flooring materials which do not need to be subjected to the antifouling treatment such as waxing, flooring materials which are coated with a composition to be cured by active energy rays such as UV rays or electron beams have been proposed (for example, see PTLs 1 and 2). An active energy ray-curable composition is a composition which is instantaneously cured by a cross-linking reaction when irradiated with active energy rays. Further, when the active energy ray-curable composition is applied to flooring materials, it is possible to provide excellent contamination resistance for the flooring materials. However, although flooring materials coated with a composition cured by the active energy rays have excellent contamination resistance, it cannot be said that the flooring materials have sufficient abrasion resistance and scratch resistance.

From the viewpoint of improving the abrasion resistance and the scratch resistance, flooring materials in which the number of functional groups and molecular weight of oligomers are specified and to which organic particles or inorganic particles are incorporated have been proposed (for example, see PTL 3). However, flooring materials including flexible polyvinyl chloride as a main component are not necessarily excellent in adhesive properties.

### CITATION LIST

### Patent Literature

[PTL 1] JP-A-6-136668

[PTL 2] JP-A-6-256444

[PTL 3] JP-A-2012-136673

### SUMMARY OF INVENTION

### Technical Problem

An object of the present invention is to provide an active energy ray-curable composition for flooring materials which more strongly adheres to flooring materials that contain vinyl chloride while maintaining conventional physical performance.

### Solution to Problem

The above-described problems are solved, by the present inventors, by, for an active energy ray-curable composition for flooring materials, using an active energy ray-polymerizable compound which includes a polyvinyl chloride-insoluble compound which does not dissolve or does not substantially dissolve in polyvinyl chloride and a polyvinyl chloride-soluble compound which dissolves in polyvinyl chloride in a specified proportion.

In regard to solubility in polyvinyl chloride, a compound in which 100 μL of an active energy ray-curable compound is added dropwise onto a base material of flexible polyvinyl chloride in an environment of 25° C., the base material is washed with a neutral detergent after the base material is allowed to stand for 2 hours, and then the base material is swollen or tackiness remains on the surface thereof is defined as a “polyvinyl chloride-soluble compound (B)” from the viewpoint of dissolving the active energy ray-curable compound in polyvinyl chloride and realizing a mixture with the active energy ray-curable compound at a molecular level. In addition, a compound other than the polyvinyl chloride-soluble compound (B) is defined as a polyvinyl chloride-insoluble compound (A).

An example in which solubility of the active energy ray-curable compound in polyvinyl chloride is evaluated using the above-described test method is shown in Table 1. These test results are merely examples and active energy ray-curable compounds showing the same characteristics are all included.

Further, evaluation criteria of the solubility in polyvinyl chloride are as follows.

A: The portion which contacts with the base material is swollen and has tackiness.

B: The portion which contacts with the base material, which is slightly swollen, can be clearly identified.

C: The portion which contacts with the base material can be identified.

D: The portion which contacts with the base material cannot be identified.

TABLE 1

| | | | Solubility in poly- |
|---|---|---|---|
| | | | vinyl chloride |
| Product name | Name of chemical product | Manufacturer | (2 hours) |
| V-CAP | N-Vinylcaprolactam | Manufactured by Ashland Inc. | A |
| VISCOAT #190 | Ethyl carbitol acrylate | Manufactured by OSAKA ORGANIC | C |
| | | CHEMICAL INDUSTRY LTD. | |
| ACMO | N-Acryloylmorpholine | Manufactured by KOHJIN Film & | B |
| | | Chemicals Co., Ltd. | |
| Beam Set 770 | N-Vinylformamide | Manufactured by Arakawa Chemical | B |
| | | Industries, Ltd. | |
| Light acrylate IOA-A | Isooctyl acrylate | Manufactured by KYOEISHA CHEMICAL | D |
| | | Co., LTD. | |
| Light acrylate PO-A | 2-Phenoxyethyl acrylate | Manufactured by KYOEISHA CHEMICAL | D |
| | | Co., LTD. | |
| MIRAMER M150 | Tetrahydrofurfuryl acrylate | Manufactured by Miwon Specialty | B |
| | | Chemical Co., Ltd. | |
| MIRAMER M200 | 1,6-Hexanediol diacrylate | Manufactured by Miwon Specialty | B |
| | | Chemical Co., Ltd. | |
| MIRAMER M202 | EO modified 1,6-Hexanediol diacrylate | Manufactured by Miwon Specialty | B |
| | | Chemical Co., Ltd. | |
| MIRAMER M210 | Hydroxypivalic acid neopentyl glycol diacrylate | Manufactured by Miwon Specialty | D |
| | | Chemical Co., Ltd. | |
| MIRAMER M220 | Tripropylene glycol diacrylate | Manufactured by Miwon Specialty | D |
| | | Chemical Co., Ltd. | |
| MIRAMER M222 | Dipropylene glycol diacrylate | Manufactured by Miwon Specialty | D |
| | | Chemical Co., Ltd. | |
| MIRAMER M260 | Tricyclodecane dimethanol diacrylate | Manufactured by Miwon Specialty | D |
| | | Chemical Co., Ltd. | |
| MIRAMER M300 | Trimethylol propane triacrylate | Manufactured by Miwon Specialty | D |
| | | Chemical Co., Ltd. | |
| MIRAMER M3130 | EO (3 mol) modified trimethylolpropane triacrylate | Manufactured by Miwon Specialty | D |
| | | Chemical Co., Ltd. | |
| | Acrylic acid | Manufactured by Nippon Shokubai Co., | D |
| | | Ltd. | |
| Light ester EH | 2-Ethylhexyl acrylate | Manufactured by KYOEISHA CHEMICAL | D |
| | | Co., LTD. | |
| SR399E | Dipentaerythritol pentaacrylate | Manufactured by SARTOMER Company Inc. | D |
| CN2303 | Hyperbranched polyester acrylate | Manufactured by SARTOMER Company Inc. | D |
| CN9026 | Urethane oligomer | Manufactured by SARTOMER Company Inc. | D |
| Photomer4703 | Carboxylic acid group-containing monoacrylate | Manufactured by IGM, Inc. | D |
| Aronix M-5300 | ω-Carboxy-polycaprolactone (n ≅ 2) monoacrylate | Manufactured by Toagosei Co., Ltd. | D |

The present invention is to provide an active energy ray-curable composition for flooring materials which contains an active energy ray-polymerizable compound and a photopolymerization initiator, in which the active energy ray-polymerizable compound includes a polyvinyl chloride-insoluble compound (A), which does not dissolve or does not substantially dissolve in polyvinyl chloride, and a polyvinyl chloride-soluble compound (B), which dissolves in polyvinyl chloride, and the content of the compound (B) is in a range of 3% to 40% by weight with respect to the content of the compound (A).

Further, the present invention is to provide the active energy ray-curable composition for flooring materials, in which the polyvinyl chloride-soluble compound (B) is a compound including one or more kinds selected from a group consisting of N-vinylcaprolactam, tetrahydrofurfuryl acrylate, N-acryloyl morpholine, N-vinylformamide, 1,6-hexanediol diacrylate, and EO-added 1,6-Hexanediol diacrylate.

Further, the present invention is to provide a flooring material or a floor which is obtained by being coated with the active energy ray-curable composition for flooring materials and then curing the composition with active energy rays.

### Advantageous Effects of Invention

According to the present invention, it is possible to provide an active energy ray-curable composition for flooring materials which more strongly adheres to flooring materials that contain vinyl chloride while maintaining conventional physical performance.

### DESCRIPTION OF EMBODIMENTS

It is effective that an active energy ray-curable composition for flooring materials of the present invention contains 3% to 40% by weight of a polyvinyl chloride-soluble compound (B) with respect to a polyvinyl chloride-insoluble compound (A). When the polyvinyl chloride-soluble compound (B) is added to the composition, polyvinyl chloride on the surface of the flooring materials is slightly dissolved and the adhesive properties of the composition can be significantly improved. The target adhesive properties cannot be obtained when the content of the active energy ray-polymerizable compound is extremely small, and polyvinyl chloride on the surface of the flooring materials is excessively dissolved when the content thereof is extremely high. This causes generation of unevenness on the surface of the flooring materials or a decrease in gloss.

Examples of the polyvinyl chloride-soluble compound (B) used in the present invention include N-vinylcaprolactam, tetrahydrofurfuryl acrylate, N-acryloyl morpholine, and N-vinylformamide. Among these, particularly, when N-vinylcaprolactam is used, the effect is remarkable. Further, these may be used alone or in combination of two or more kinds thereof.

The polyvinyl chloride-insoluble compound (A) used in the present invention is not particularly limited as long as an active energy ray-polymerizable compound other than the active energy ray-polymerizable compound having the above-described properties is used. Specific examples thereof may include active energy ray-polymerizable compounds which can be used in combination as described below.

(Active Energy Ray-Polymerizable Compound)

The active energy ray-polymerizable compound to be used in the present invention can be used by arbitrarily selecting any of known (meth)acrylic monomers and/or (meth)acrylic oligomers typically used for an active energy ray-curable composition. Moreover, in the present invention, “(meth)acryl” is a general term for acryl and methacryl.

Examples of the (meth)acrylic monomer include unsaturated carboxylic acid or an ester thereof such as acrylic acid or methacrylic acid, for example, alkyl (meth)acrylate, cycloalkyl (meth)acrylate, halogenated alkyl (meth)acrylate, alkoxy alkyl (meth)acrylate, hydroxy alkyl (meth)acrylate, aminoalkyl (meth)acrylate, allyl (meth)acrylate, glycidyl (meth)acrylate, benzyl (meth)acrylate, phenoxy (meth)acrylate, mono or di(meth)acrylate of alkylene glycol or polyoxyalkylene glycol, trimethylolpropane tri(meth)acrylate, and pentaerythritol tetra(meth)acrylate; (meth)acrylamide or a derivative thereof such as (meth)acrylamide, diacetone (meth)acrylamide, or N,N′-alkylene bis(meth)acrylamide which is mono-substituted or di-substituted with an alkyl group or a hydroxyalkyl group; and an allyl compound such as allyl alcohol, allyl isocyanate, diallyl phthalate, or triallyl isocyanurate.

Other examples of the (meth)acrylic monomer include polyethylene glycol (n is in a range of 3 to 14) di(meth)acrylate, trimethylolpropane EO-modified (n is in a range of 3 to 14) tri(meth)acrylate, or phenol EO-modified (n is in a range of 3 to 14) (meth)acrylate which has an ethylene glycol unit in a molecule; and 2-hydroxyethyl (meth)acrylate, 2-hydroxypropyl (meth)acrylate, 4-hydroxybutyl (meth)acrylate, pentaerythritol tri(meth)acrylate, or phthalic acid monohydroxyethyl (meth)acrylate which has a hydroxyl group in a molecule.

These (meth)acrylic monomers may be used alone or in combination of two or more kinds thereof.

For applications in which curing shrinkage is an obstruction, it is possible to use isobornyl (meth)acrylate, norbornyl (meth)acrylate, dicyclopentenoxy ethyl (meth)acrylate, or dicyclopentenoxy propyl (meth)acrylate; acrylic acid ester or methacrylic acid ester of diethylene glycol dicyclopentenyl monoether, acrylic acid ester or methacrylic acid ester of polyoxyethylene or polypropylene glycol dicyclopentenyl monoether; dicyclopentenyl cinnamate, dicyclopentenoxy ethyl cinnamate, dicyclopentenoxy ethyl monofumarate, or dicyclopentenoxy ethyl difumarate; a monomer, diacrylate, monomethacrylate, or dimethacrylate of 3,9-bis(1,1-bismethyl-2-oxyethyl)-spiro[5,5]undecane, 3,9-bis(1,1-bismethyl-2-oxyethyl)-2,4,8,10-tetraoxaspiro[5,5]undecane, 3,9-bis(2-oxyethyl)-spiro[5,5]undecane, or 3,9-bis(2-oxyethyl)-2,4,8,10-tetraoxaspiro[5,5]undecane; monoacrylate, diacrylate, monomethacrylate, or dimethacrylate of an ethylene oxide addition polymer or a propylene oxide addition polymer of spiroglycol of these; methyl ether of the mono(meth)acrylate, 1-azabicyclo[2,2,2,2]-3-octenyl (meth)acrylate, or bicycle[2,2,1]-5-heptene-2,3-dicarboxyl monoallyl ester; and a (meth)acrylic monomer of dicyclopentadienyl (meth)acrylate, dicyclopentadienyl oxyethyl (meth)acrylate, or dihydrodicyclopentadienyl (meth)acrylate.

These active energy ray-polymerizable compounds may be used alone or in combination of two or more kinds thereof.

Examples of the active energy ray-polymerizable compound that are particularly preferable for the composition include monofunctional monomers, for example, (meth)acrylate including a substituent such as methyl, ethyl, propyl, butyl, amyl, 2-ethylhexyl, isooctyl, nonyl, dodecyl, hexadecyl, octadecyl, cyclohexyl, benzyl, methoxyethyl, butoxyethyl, phenoxyethyl, nonylphenoxyethyl, glycidyl, dimethylaminoethyl, diethylaminoethyl, isobornyl, dicyclopentanyl, dicyclopentenyl, or dicyclopentenyloxyethyl, ω-carboxy-polycaprolactone monoacrylate, phthalic acid monohydroxyethyl acrylate, 2-hydroxy-3-phenoxypropyl acrylate, vinylpyrrolidone, acryloyl morpholine, and N-vinylformamide; and polyfunctional monomers, for example, di(meth)acrylate such as 1,3-butylene glycol, 1,4-butanediol, 1,5-pentanediol, 3-methyl-1,5-pentanediol, 1,6-hexanediol, neopentyl glycol, 1,8-octanediol, 1,9-nonanediol, tricyclodecane dimethanol, ethylene glycol, polyethylene glycol, propylene glycol, dipropylene glycol, tripropylene glycol, or polypropylene glycol, di(meth)acrylate of tris(2-hydroxyethyl)isocyanurate, 2-(2-vinyloxyethoxy)ethyl (meth)acrylate, di(meth)acrylate of a diol obtained by adding 4 moles or more of ethylene oxide or propylene oxide to one mole of neopentyl glycol, di(meth)acrylate of a diol obtained by adding 2 moles of ethylene oxide or propylene oxide to 1 mole of bisphenol A, di- or tri(meth)acrylate of a triol obtained by adding 3 moles or more of ethylene oxide or propylene oxide to 1 mole of trimethylol propane, di(meth)acrylate of a diol obtained by adding 4 moles or more of ethylene oxide or propylene oxide to 1 mole of bisphenol A, trimethylolpropane tri(meth)acrylate, pentaerythritol tri(meth)acrylate, poly(meth)acrylate of dipentaerythritol, ethylene oxide-modified phosphoric acid (meth)acrylate, and ethylene oxide-modified alkyl phosphoric acid (meth)acrylate. These may be used in combination of two or more kinds thereof.

((Meth)Acrylic Oligomer)

An oligomer contained in the active energy ray-curable composition according to the embodiment is a compound to be cross-linked or polymerized by irradiation with light. Further, this compound has a polymer of monomers as a main chain and the number of monomers constituting the main chain is not limited. The molecular weight of the oligomer is preferably in a range of 500 to 20,000.

The number of the functional groups of the oligomer is preferably in a range of 2 to 20, more preferably 4 to 20, and still more preferably 6 to 20. The functional group included in the oligomer is a photopolymerizable functional group. The photopolymerizable functional group is a double bond of carbon-carbon such as an acryloyl group, or the like. When the number of functional groups is large, curing sensitivity of the curable oligomer becomes high and the hardness of a cured coating film is also enhanced. Meanwhile, when the number of functional groups is excessively large, shrinkage of a cured coating film is likely to occur and the surface of the coating film is likely to be distorted.

The glass transition temperature (Tg) of the oligomer is preferably 40° C. or higher, more preferably 50° C. or higher, and still more preferably 70° C. or higher. The glass transition temperature (Tg) can be measured by differential scanning calorimetry (DSC) or thermal mechanical analysis (TMA).

The viscosity of the oligomer is not particularly limited, but the viscosity thereof at 25° C. is preferably in a range of 100 to 10,000 mPa·s, more preferably 5,000 mPa·s or less, and still more preferably 1,000 mPa·s or less in consideration of influence on the handling properties and the viscosity of the active energy ray-curable composition.

The main chain of the oligomer may be polyepoxy, aliphatic polyurethane, aromatic polyurethane, aliphatic polyester, aromatic polyester, polyamine, or polyacrylate. It is preferable that the above-described photopolymerizable functional group is added to the main chain of the oligomer.

The following (photopolymerizable) functional group-containing compounds can be reacted with the main chain of the oligomer by the functional group of the oligomer and then introduced thereto. Examples of the (photopolymerizable) functional group-containing compound include unsaturated carboxylic acid such as (meth)acrylic acid, itaconic acid, crotonic acid, isocrotonic acid, or maleic acid and salts or esters thereof, urethane, an amide and an anhydride thereof, acrylonitrile, styrene, various unsaturated polyesters, unsaturated polyether, unsaturated polyamide, and unsaturated urethane. In addition, an N-vinyl compound may be also included. Examples of the N-vinyl compound include N-vinylformamide, N-vinylcarbazole, N-vinylacetamide, N-vinylpyrrolidone, N-vinylcaprolactam, acryloyl morpholine, and derivatives thereof.

Preferred examples of the oligomer include epoxy (meth)acrylate, amine (meth)acrylate, aliphatic urethane (meth)acrylate, aromatic urethane (meth)acrylate, aliphatic polyester (meth)acrylate, and aromatic polyester (meth)acrylate.

In order to raise the glass transition temperature (Tg) of the oligomer, an aromatic ring or an amide structure may be introduced to the main chain of the oligomer so that the main chain structure becomes rigid, or a large substituent may be introduced to the side chain of the oligomer.

The oligomer may be a linear, branched chain-like, or dendritic oligomer, but a branched chain-like or dendritic oligomer is preferable in some cases. Since the viscosity of the branched chain-like or dendritic oligomer is relatively low, the hardness of a cured film can be enhanced despite that the viscosity of the active energy ray-curable composition of flooring materials is unlikely to be increased. The dendritic oligomer indicates an oligomer having a plurality of branched chains in one molecule.

Examples of the dendritic oligomer include a dendrimer, a hyperbranched oligomer, a star oligomer, and a graft oligomer. A dendrimer, a hyperbranched oligomer, a star oligomer, and a graft oligomer may be known compounds. Among these, a dendrimer or a hyperbranched oligomer is preferable and the hyperbranched oligomer is more preferable. It is difficult for a dendrimer or a hyperbranched oligomer to further increase the viscosity of the active energy ray-curable composition.

The hyperbranched oligomer indicates an oligomer formed by bonding a plurality of photopolymerizable functional groups to an oligomer to which two or more monomers are bonded as a repeating unit. The hyperbranched oligomer typically includes multiple photopolymerizable functional groups. For this reason, the curing rate of the active energy ray-curable composition of flooring materials can be further increased and the hardness of the cured film can be further increased by the hyperbranched oligomer. The number of photopolymerizable functional groups included in one molecule of hyperbranched oligomer is preferably 6 or greater.

Examples of the hyperbranched oligomer include polyester hexa-functional acrylate, polyester nona-functional acrylate, and polyester 16-functional acrylate.

Examples of commercially available products of the oligomer are as follows.

CN131B, CN292, CN2272, CN2303, CN2304, CN509, CN551, CN790, CN2400, CN2401, CN2402, CN9011, and CN9026 (all manufactured by Sartomer Co., Ltd.); EBECRYL 600, EBECRYL 605, EBECRYL 3700, EBECRYL 3701, EBECRYL 3702, EBECRYL 3703, EBECRYL 1830, EBECRYL 80, EBECRYL 8210, and EBECRYL 8301 (all manufactured by Daicel Cytec Co., Ltd.); and Etercure 6147, Etercure 6172-1, Etercure 6153-1, Etercure 6175-3, Etercure 6234, and Etercure 6237 (all manufactured by Eternal Chemical Co., LTD.)

Particularly, examples of commercially available products of the hyperbranched oligomer are as follows.

CN2300, CN2301, CN2302, and CN2303 (all manufactured by Sartomer Co., Ltd.); Etercure 6361-100 and Etercure 6362-100 (both manufactured by Eternal Chemical Co., LTD.); and V#1000 and V#1020 (both manufactured by OSAKA ORGANIC CHEMICAL INDUSTRY LTD.)

(Photopolymerization Initiator)

A known photopolymerization initiator of the related art may be used as the photopolymerization initiator used in the present invention, and specifically benzoin isobutyl ether, 2,4-diethyl thioxanthone, 2-isopropyl thioxanthone, benzyl, 2,4,6-trimethylbenzoyl diphenyl phosphine oxide, 6-trimethyl benzoyl diphenyl phosphine oxide, 2-benzyl-2-dimethylamino-1-(4-morpholinophenyl)-butane-1-one, and bis(2,6-dimethoxybenzoyl)-2,4,4-trimethylpentyl phosphine oxide are preferably used. Further, examples of a molecule cleavage type photopolymerization initiator, other than these described above, which can be used in combination include 1-hydroxy cyclohexyl phenyl ketone, benzoin ethyl ether, benzyl dimethyl ketal, methyl benzoyl formate, 2-hydroxy-2-methyl-1-phenylpropane-1-one, 1-(4-isopropylphenyl)-2-hydroxy-2-methylpropane-1-one, and 2-methyl-1-(4-methylthiophenyl)-2-morpholinopropane-1-one. Further, examples of a hydrogen abstraction type photopolymerization initiator which can be used in combination include benzophenone, 4-phenylbenzophenone, isophthal phenone, and 4-benzoyl-4′-methyl-diphenyl sulfide.

Particularly, in a case where a light emitting diode (hereinafter, also referred to as an LED) is used as a light source, it is preferable to select a photopolymerization initiator in consideration of the emission peak wavelength of the LED. Examples of the photopolymerization initiator suitable for a case of using a UV-LED include 2-benzyl-2-dimethylamino-1-(4-morpholinophenyl)-butane-1-one, 2-(dimethylamino)-2-[(4-methylphenyl)methyl]-1-(4-morpholinophenyl)-butane-1-one), bis(2,4,6-trimethylbenzoyl)phenyl phosphine oxide, 2,4,6-trimethylbenzoyl-diphenyl-phosphine oxide, 2,4-diethyl thioxanthone, and 2-isopropylthioxanthone.

Amines, which do not cause an addition reaction with the above-described polymerizable components, such as trimethylamine, methyldimethanolamine, triethanolamine, p-diethylaminoacetophenone, ethyl p-dimethylaminobenzoate, isoamyl p-dimethylaminobenzoate, N,N-dimethylbenzylamine, and 4,4′-bis(diethylamino)benzophenone can be used, as sensitizers, in combination with the above-described photopolymerization initiators.

These photopolymerization initiators may be used alone or in combination of two or more kinds thereof.

The content of the photopolymerization initiator is not particularly limited, but the photopolymerization initiator is blended approximately in an amount of 2% to 20% by mass with respect to the total amount.

(Filler)

When organic particles or inorganic particles are added to the active energy ray-curable composition for flooring materials of the present invention, the scratch resistance thereof becomes more excellent. Examples of the organic particles used in the present invention include an acrylic resin, a urethane resin, a fluorine resin, silicone, a melamine resin, and a styrene resin and examples of the inorganic particles include calcium carbonate, silica, alumina, titanium oxide, magnesium hydroxide, zinc oxide, calcium silicate, and aluminum hydroxide. These may be used alone or in combination and, among these, alumina is preferably used. Further, the average particle diameter of the above-described organic particles and inorganic particles is preferably 10 μm or less. The organic particles and inorganic particles may be added alone or may be added after being dispersed in a suitable dispersion medium in advance.

The amount of the organic particles and inorganic particles to be added is preferably 10 parts by weight or less, and more preferably in a range of 1 to 5 parts by weight, with respect to 100 parts by weight of the active energy ray-polymerizable compound.

(Colorant)

It is possible to provide design properties for the active energy ray-curable composition for flooring materials by coloring the composition. For coloration, an inorganic pigment or an organic pigment can be used as a conventionally known colorant. An organic pigment or an inorganic pigment can be used as a pigment used in the present invention.

Examples of the inorganic pigment which can be used include silicas such as sulfate of alkaline earth metal, carbonate, fine silicic acid, and synthetic silicate; an inorganic pigment used as a white pigment such as calcium silicate, alumina, an alumina hydrate, titanium oxide, zinc oxide, talc, or clay; iron oxide; and carbon black produced by a known method such as a contact method, a furnace method, or a thermal method.

Moreover, examples of the organic pigment which can be used include azo pigments (including azo lake, an insoluble azo pigment, a condensed azo pigment, and a chelate azo pigment), polycyclic pigments (such as a phthalocyanine pigment, a perylene pigment, a perinone pigment, an anthraquinone pigment, a quinacridone pigment, a dioxazine pigment, a thioindigo pigment, an isoindolinone pigment, and a quinophthalone pigment), dye chelate (such as basic dye chelate or acid dye chelate), nitro pigments, nitroso pigments, and aniline black.

Specific examples of the pigment which is carbon black include No. 2300, No. 900, No. 960, MCF 88, No. 33, No. 40, No. 45, No. 52, MA7, MA8, MA100, and No. 2200B (manufactured by Mitsubishi Chemical Corporation); Raven 5750, Raven 5250, Raven 5000, Raven 3500, Raven 1255, and Raven 700 (manufactured by Columbia Carbon, Inc.); Regal 400R, Regal 330R, Regal 660R, Mogul L, Mogul 700, Monarch 800, Monarch 880, Monarch 900, Monarch 1000, Monarch 1100, Monarch 1300, and Monarch 1400 (manufactured by Cabot Corporation); and Color Black FW1, Color Black FW2, Color Black FW2V, Color Black FW18, Color Black FW200, Color Black S150, Color Black S160, Color Black S170, Printex 35, Printex U, Printex V, Printex 140U, Special Black 6, Special Black 5, Special Black 4A, and Special Black 4 (manufactured by Degussa AG).

Examples of pigments used for a yellow color include C. I. Pigment Yellow 1, 2, 3, 12, 13, 14, 16, 17, 73, 74, 75, 83, 93, 95, 97, 98, 109, 110, 114, 120, 128, 129, 138, 150, 151, 154, 155, 180, 185, and 213.

Further, examples of pigments used for a magenta color include C. I. Pigment Red 5, 7, 12, 48 (Ca), 48 (Mn), 57 (Ca), 57:1, 112, 122, 123, 168, 184, 202, and 209, and C. I. Pigment Violet 19.

Further, examples of pigments used for a cyan color include C. I. Pigment Blue 1, 2, 3, 15:3, 15:4, 60, 16, and 22.

Moreover, as pigments used for a white color, C. I. Pigment White 6, 18, and 21 can be used according to the purpose thereof, and titanium oxide with excellent opacity is preferable. Specific examples thereof include “TITANIX JR-301, 403, 405, 600A, 605, 600E, 603, 805, 806, 701, 800, and 808”, and “TITANIX JA-1, C, 3, 4, and 5” (all manufactured by TAYCA CORPORATION); “TIPAQUE CR-50, 50-2, 57, 80, 90, 93, 95, 953, 97, 60, 60-2, 63, 67, 58, 58-2, and 85”, “TIPAQUE R-820, 830, 930, 550, 630, 680, 670, 580, 780, 780-2, 850, and 855”, “TIPAQUE A-100 and 220”, “TIPAQUE W10”, “TIPAQUE PF-740 and 744”, “TTO-55(A), 55(B), 55(C), 55(D), 55(S), 55(N), 51(A), and 51(C)”, “TTO-S-1 and 2”, and “TTO-M-1 and 2” (all manufactured by ISHIHARA SANGYO KAISHA, LTD.); and “TI-PURE R-900, 902, 960, 706, and 931” (manufactured by Du Pont).

(Additive)

As other additives, conventionally known additives such as a photosensitizer, an antifoaming agent, a leveling agent, a UV absorbent, a light stabilizer, a lubricant, and a matting agent can be added to the active energy ray-curable composition for flooring materials. In addition, an antibacterial agent or an antistatic agent can be suitably added if necessary for the purpose of providing functionality.

In order to improve storage stability, polymerization inhibitors such as hydroquinone, methoquinone, a hindered amine-based light stabilizer, a hindered phenol-based light stabilizer, di-t-butyl hydroquinone, P-methoxyphenol, butyl hydroxy toluene, and nitrosamine salts can be added to the active energy ray-curable composition for flooring materials of the present invention in an amount of 0.01% to 2% by mass.

In addition, a dispersant may be used to improve dispersion stability of a filler. Examples of the dispersant include AJISPER PB821, PB822, PB881, and PB817 (manufactured by Ajinomoto Fine-Techno Co., Inc.); SOLSPERSE 24000GR, 32000, 33000, 36000, 39000, 41000, and 71000 (manufactured by Lubrizol Corporation); EFKA-7701 (manufactured by BASF Corporation); and DISPARLON DA-703-50, DA-705, and DA-725 (manufactured by Kusumoto Chemicals, Ltd.), but the examples are not limited to these. The amount of the dispersant to be used is preferably in a range of 10% to 80% by weight and particularly preferably in a range of 20% to 60% by weight with respect to the filler. In a case where the amount of the dispersant to be used is less than 10% by weight, the dispersion stability tends to be insufficient. In a case where the amount thereof exceeds 80% by mass, the viscosity of the active energy ray-curable composition for flooring materials tends to be higher and leveling properties of the active energy ray-curable composition for flooring materials are deteriorated.

For the purpose of providing adhesive properties for a printed base material, it is possible to blend non-reactive resins such as an acrylic resin, an epoxy resin, a terpene phenol resin, and rosin ester with the base material.

(Method of Producing Active Energy Ray-Curable Composition for Flooring Materials)

An active energy ray curable composition can be obtained by blending necessary active energy ray-polymerizable compounds and heating the mixture while stirring and mixing a photopolymerization initiator and a photopolymerization inhibitor. In order to obtain the active energy ray-curable composition for flooring materials of the present invention, an additive such as a surface tension adjusting agent or a lubricant necessary for the active energy ray curable composition for flooring materials is added and then stirred, thereby obtaining the active energy ray curable composition.

(Viscosity of Active Energy Ray Curable Composition for Flooring Materials)

Since streaky feeling may occur at the time of finish after curing when the viscosity of the active energy ray curable composition for flooring materials of the present invention is excessively high, the viscosity thereof is preferably in a range of 50 to 1,000 mPa-sec and most preferably in a range of 100 to 400 mPa-sec.

(Coating Method)

As a coating method of the active energy ray-curable composition for flooring materials, application of the composition is performed using a roller or brush. Further, the active energy ray-curable composition for flooring materials can be used for various inks or for coating. As the coating method, known techniques such as a roll coater, a gravure coater, a flexo coater, an air doctor coater, a blade coater, an air knife coater, a squeeze coater, an impregnation coater, a transfer roll coater, a kiss coater, a curtain coater, a cast coater, a spray coater, a die coater, an offset printing machine, and a screen printing machine can be suitably employed.

(Curing)

The active energy ray-curable composition for flooring materials is subjected to a curing reaction by performing irradiation with active energy rays and preferably UV rays. The light sources of the UV rays can be used for curing without any problems as long as the light sources typically used for a UV-curable coating agent such as a metal halide lamp, a xenon lamp, a carbon arc lamp, a chemical lamp, a low-pressure mercury lamp, and a high-pressure mercury lamp are used. For example, the curing can be performed using commercially available light sources such as a H lamp, a D lamp, and a V lamp (manufactured by Fusion Systems).

In recent years, there is a demand that the active energy ray-curable composition for flooring materials is to be cured or semi-cured using sources for irradiation with active energy rays such as a UV-LED or UV light emitting semiconductor laser. For example, in a case where the sources are used for the active energy ray-curable composition for flooring materials, a floor can be formed by performing a process of coating flooring materials with the active energy ray-curable composition for flooring materials and then curing the active energy ray-curable composition by irradiating the composition with active energy rays whose wavelength peak is present in a range of 365 to 420 nm using a light emitting diode (LED).

### EXAMPLES

Hereinafter, the present invention will be described in more detail with reference to examples, but the present invention is not particularly limited to the following examples. Further, the “part” in the following examples indicates part by mass.

(Examples Active Energy Ray Curable Composition for Flooring Material)

After 3.0 parts of N-vinylcaprolactam “V-CAP/RC” (manufactured by Ashland Inc.), 20.4 parts of dipropylene glycol diacrylate “MIRAMER M222” (manufactured by Miwon Specialty Chemical Co., Ltd.), 21.0 parts of hyperbranched polyester acrylate “CN2303” (manufactured by SARTOMER Company Inc.), 14.0 parts of 3 mol of ethylene oxide-added trimethylolpropane triacrylate “MIRAMER M3130” (manufactured by Miwon Specialty Chemical Co., Ltd.), 10.0 parts of ω-carboxy-polycaprolactone monoacrylate “Aronix M-5300” (manufactured by Toagosei Co., Ltd.), 22.0 parts of urethane oligomer “CN9026” (manufactured by SARTOMER Company Inc.), 2.0 parts of 1-hydroxy-cyclohexyl-phenyl-ketone “Irgacure184” (manufactured by BASF Corporation), 5.0 parts by methylbenzoyl formate “DAROCUR MBF” (manufactured by BASF Corporation), and 0.1 parts of butyl hydroxy toluene “H-BHT” (manufactured by Honshu Chemical Industry Co., Ltd.) were added, heated at 60° C. for 30 minutes, and then stirred, 1.0 part of a polyethylene dispersion “CC7610” (manufactured by Lubrizol Corporation) and 1.5 parts of a leveling agent “BYK-350” (manufactured by BYK-Chemie GmbH) were added thereto, and then the mixture were sufficiently mixed with each other. Next, the mixture was filtered using a filter having an opening diameter of 100 μm, thereby obtaining an active energy ray-curable composition for flooring materials.

In Examples 2 to 8 and Comparative Examples 1 to 4, active energy ray-curable compositions for flooring materials were obtained in the same manner as in Example 1 except for following the compositions indicated in Tables 2 and 3.

Further, the surface (walking surface) of composition vinyl floor tile “MATICO V” (manufactured by TOLI Corporation) and homogeneous vinyl floor tile “Royal Wood PWT563” (manufactured by TOLI Corporation) was coated with the active energy ray-curable composition having the above-described mixture such that the thickness thereof became 40 μm, and the surface thereof was irradiated with UV rays (irradiation dose: 500 mJ/cm²) to cure the active energy ray-curable composition for flooring materials, thereby obtaining a flooring material.

TABLE 2

| | Examples | | | | | | | |
|---|---|---|---|---|---|---|---|---|
| | 1 | 2 | 3 | 4 | 5 | 6 | 7 | 8 |
| V-Cap | 3.0 | 23.9 | | | | | | 40.0 |
| MIRAMER M150 | | | 23.9 | | | | | |
| MIRAMER M200 | | | | 23.9 | | | | |
| MIRAMER M202 | | | | | 23.9 | | | |
| ACMO | | | | | | 23.9 | | |
| Beam Set 770 | | | | | | | 23.9 | |
| Light Acrylate PO-A | | | | | | | | |
| MIRAMER M222 | 20.4 | | | | | | | |
| CN2303 | 21.0 | 20.5 | 20.5 | 20.5 | 20.5 | 20.5 | 20.5 | 6.9 |
| MIRAMER M3130 | 14.0 | 14.0 | 14.0 | 14.0 | 14.0 | 14.0 | 14.0 | 11.5 |
| Aronix M-5300 | 10.0 | 10.0 | 10.0 | 10.0 | 10.0 | 10.0 | 10.0 | 10.0 |
| CM9026 | 22.0 | 22.0 | 22.0 | 22.0 | 22.0 | 22.0 | 22.0 | 22.0 |
| Irgacure184 | 2.0 | 2.0 | 2.0 | 2.0 | 2.0 | 2.0 | 2.0 | 2.0 |
| Darocur MBF | 5.0 | 5.0 | 5.0 | 5.0 | 5.0 | 5.0 | 5.0 | 5.0 |
| H-BHT | 0.1 | 0.1 | 0.1 | 0.1 | 0.1 | 0.1 | 0.1 | 0.1 |
| BYK-350 | 1.5 | 1.5 | 1.5 | 1.5 | 1.5 | 1.5 | 1.5 | 1.5 |
| CC7610 | 1.0 | 1.0 | 1.0 | 1.0 | 1.0 | 1.0 | 1.0 | 1.0 |
| Total | 100.0 | 100.0 | 100.0 | 100.0 | 100.0 | 100.0 | 100.0 | 100.0 |

TABLE 3

Comparative Examples

| | 1 | 2 | 3 | 4 |
|---|---|---|---|---|
| V-Cap | | | 2.5 | 45.0 |
| MIRAMER M150 | | | | |
| MIRAMER M200 | | | | |
| MIRAMER M202 | | | | |
| ACMO | | | | |
| Beam Set 770 | | | | |
| Light Acrylate PO-A | 23.9 | | | |
| MIRAMER M222 | | 23.9 | 21.4 | |
| CN2303 | 20.5 | 20.5 | 20.5 | 5.0 |
| MIRAMER M3130 | 14.0 | 14.0 | 14.0 | 8.4 |
| Aronix M-5300 | 10.0 | 10.0 | 10.0 | 10.0 |
| CN9026 | 22.0 | 22.0 | 22.0 | 22.0 |
| Irgacure184 | 2.0 | 2.0 | 2.0 | 2.0 |
| Darocur MBF | 5.0 | 5.0 | 5.0 | 5.0 |
| H-BHT | 0.1 | 0.1 | 0.1 | 0.1 |
| BYK-350 | 1.5 | 1.5 | 1.5 | 1.5 |
| CC7610 | 1.0 | 1.0 | 1.0 | 1.0 |
| Total | 100.0 | 100.0 | 100.0 | 100.0 |

V-Cap: N-vinylcaprolactam (manufactured by Ashland Inc.)

MIRAMER M-150: tetrahydrofurfuryl acrylate (manufactured by Miwon Specialty Chemical Co., Ltd.)

MIRAMER M-200: 1,6-hexanediol diacrylate (manufactured by Miwon Specialty Chemical Co., Ltd.)

MIRAMER M-202: EO-added 1,6-Hexanediol diacrylate (manufactured by Miwon Specialty Chemical Co., Ltd.)

ACMO: N-acryloylmorpholine (manufactured by KOHJIN Film & Chemicals Co., Ltd.)

Beam Set 770: N-vinylformamide (manufactured by Arakawa Chemical Industries, Ltd.)

Light acrylate PO-A: 2-phenoxyethyl acrylate (manufactured by KYOEISHA CHEMICAL Co., LTD.)

MIRAMER M-222: dipropylene glycol diacrylate (manufactured by Miwon Specialty Chemical Co., Ltd.)

CN2303: hyperbranched polyester acrylate (manufactured by SARTOMER Company Inc.)

MIRAMER M-3130: 3 mol of ethylene oxide-added trimethylolpropane triacrylate (manufactured by Miwon Specialty Chemical Co., Ltd.)

Aronix M-5300: ω-carboxy-polycaprolactone monoacrylate (manufactured by Toagosei Co., Ltd.)

CN9026: urethane oligomer (manufactured by SARTOMER Company Inc.)

Irgacure184: 1-hydroxy-cyclohexyl-phenyl-ketone (manufactured by BASF Corporation)

DAROCUR MBF: methylbenzoyl formate (manufactured by BASF Corporation)

H-BHT: butyl hydroxy toluene (manufactured by Honshu Chemical Industry Co., Ltd.)

CC7610: polyethylene dispersion (manufactured by Lubrizol Corporation)

BYK-350: leveling agent (manufactured by BYK-Chemie GmbH)

(Evaluation Method)

With respect to Examples 1 to 8 and Comparative Examples 1 to 4, evaluation methods performed on the active energy ray-curable compositions for flooring materials will be described.

[Scratch Resistance]

Steel Wool No. 000 was mounted on the tip of an arm of a plane friction test machine (manufactured by TOYO SEIKI SEISAKU-SHO, LTD.), 500 g of a load was applied thereto, the surface of a coating film was reciprocally rubbed 100 times, and then presence or absence of scratches was observed.

A: Scratches were not found.

B: Scratches were not noticeable.

C: Scratches were slightly noticeable.

D: Many scratches were found and a part of the surface had peeling portions.

[Adhesive Properties of Base Material]

The quality of adhesive properties was determined by performing evaluation on samples prepared in the examples and the comparative examples described above in conformity with the cross-cut tape method described in JIS K 5400. The evaluation criteria are shown in Table 4.

TABLE 4

| Evaluation scores | State of scratches |
|---|---|
| 10 | Each cut is thin and both ends thereof are smooth. |
| | There is no peeling with respect to every point of |
| | the intersections of cuts and every square. |
| 8 | Peeling is slightly found with respect to the |
| | intersection of cuts, but there is no peeling with |
| | respect to every square. The area of the defective |
| | portions is within 5% based on the area of the |
| | entire squares. |
| 6 | Peeling is significant with respect to both sides |
| | of a cut and the intersection of cuts. The area of |
| | the defective portions is in a range of 5% to 15% |
| | based on the area of the entire squares. |
| 4 | The width of the peeling due to a cut is large. |
| | The area of the defective portions is in a range of |
| | 15% to 35% based on the area of the entire squares. |
| 2 | The width of the peeling due to a cut is large. |
| | The area of the defective portions is in a range of |
| | 15% to 35% based on the area of the entire squares. |
| 0 | The area of the peeling is 65% or greater based on |
| | the area of the entire squares. |

The evaluation results are shown in Table 5.

TABLE 5
Evaluation items (Table 5)

| | | | | | | | | | | Comparative | | | |
|---|---|---|---|---|---|---|---|---|---|---|---|---|---|
| | | Examples | | | | | | | | Examples | | | |
| | | 1 | 2 | 3 | 4 | 5 | 6 | 7 | 8 | 1 | 2 | 3 | 4 |
| Scratch resistance | | A | A | B | A | A | A | A | A | D | C | A | D |
| Adhesive | With respect to | 10 | 10 | 10 | 10 | 10 | 10 | 10 | 10 | 8 | 8 | 10 | 10 |
| properties | composition | | | | | | | | | | | | |
| of base | vinyl floor tile | | | | | | | | | | | | |
| material | With respect to | 10 | 10 | 10 | 10 | 10 | 10 | 10 | 10 | 0 | 0 | 2 | 10 |
| | homogeneous | | | | | | | | | | | | |
| | vinyl floor tile | | | | | | | | | | | | |

As a result, in the active energy ray-curable compositions for flooring materials obtained in the examples according to the present invention, flooring materials with excellent adhesive properties with respect to the base material were able to be obtained without deteriorating the gloss of the base material.

1. An active energy ray-curable composition for flooring materials,
which comprises an active energy ray-polymerizable compound and a photopolymerization initiator,
wherein the active energy ray-polymerizable compound includes a polyvinyl chloride-insoluble compound (A), which does not dissolve or does not substantially dissolve in polyvinyl chloride, and a polyvinyl chloride-soluble compound (B), which dissolves in polyvinyl chloride, and the content of the compound (B) is in a range of 3% to 40% by weight with respect to the content of the compound (A).

2. The active energy ray-curable composition for flooring materials according to claim 1, wherein the polyvinyl chloride-soluble compound (B) is at least one selected from the group consisting of N-vinylcaprolactam, tetrahydrofirfuryl acrylate, N-acryloyl morpholine, N-vinylformamide, 1,6-hexanediol diacrylate, and EO-added 1,6-hexanediol diacrylate.

3. A flooring material or a floor, which is obtained by performing coating with the active energy ray-curable composition for flooring materials according to claim 1 and then curing the composition with active energy rays.
